(19) United States
(12) Patent Application Publication
(10) Pub. No.: US 2023/0358577 A1
(43) Pub. Date: Nov. 9, 2023

(54) DETECTION DEVICE FOR SECURING TO OR IN A VEHICLE COMPONENT FOR DETECTING PHYSICAL AND/OR CHEMICAL VARIABLES

(71) Applicant: ZF Friedrichshafen AG, Friedrichshafen (DE)

(72) Inventors: Philipp Lang, Lübeck (DE); Martin Hermann, Salem (DE); Michael Schwab, Markdorf (DE); Christopher Winter, Konstanz (DE); Thomas Stauderer, Friedrichshafen (DE); Ulrich Mair, Friedrichshafen (DE)

(73) Assignee: ZF Friedrichshafen AG, Friedrichshafen (DE)

(21) Appl. No.: 18/245,268

(22) PCT Filed: Sep. 10, 2021
(86) PCT No.: PCT/EP2021/074909

§ 371 Date: Mar. 14, 2023

(30) Foreign Application Priority Data
Sep. 14, 2020 (DE) 10 2020 211 488.9

(51) Int. Cl. G01D 11/30; G01D 11/24

(52) U.S. Cl. CPC G01D 11/30; G01D 11/245

(57) ABSTRACT

A detection device may be attached to or secured in a vehicle component, with which physical and/or chemical values can be detected. The device may include of at least one of the following: a detection unit placed or formed on a first mount for detecting a physical and/or chemical value, wherein the first mount has at least one mounting interface for attaching the first mount to the vehicle component; and a functional unit to which the detection unit is dedicated, placed or formed on or in a second mount, wherein the second mount has at least one connecting interface for connecting the second mount to the first mount.

### RELATED APPLICATIONS

This application is a filing under 35 U.S.C. § 371 of International Patent Application PCT/EP2021/074909, filed Sep. 10, 2021, and claiming priority to German Patent Application 10 2020 211 488.9, filed Sep. 14, 2020. All applications listed in this paragraph are hereby incorporated by reference in their entireties.

### BACKGROUND AND BRIEF DESCRIPTION

The invention relates to a detection device that can be attached to or secured in a vehicle component, with which physical and/or chemical values can be detected.

Detection devices of this type are fundamentally known in the prior art. These can be sensor modules, for example, which comprise a sensor unit for determining a physical value, a power source, and a wireless transmitter. The components of the sensor unit form a discreet module in this case, which is attached to an object. If one of the components in the sensor unit malfunctions, the entire sensor module must be replaced, in which case the detection information obtained from the new sensor unit may differ from the detection information from the original sensor unit with regard to its modality. The detection information obtained from the new sensor unit typically requires modification, and/or the new sensor unit has to be calibrated.

The fundamental object of the invention is to create a detection device with which the quality and operation of the detection device is improved and simplified, in particular in a simple and quick, as well as inexpensive, manner, particularly with regard to use of the detection device over a long period of time.

This problem is solved by a detection device that can be attached to or secured in a vehicle component, with which physical and/or chemical values can be detected according to the independent claims. The dependent claims relate to possible embodiments of the detection device.

The invention relates to a detection device that can be attached to or secured in a vehicle component, with which physical and/or chemical values can be detected, in particular those acting on the vehicle component. The detection device is distinctive in that it has the following features, (a) a detection unit for detecting physical and/or chemical values, placed or formed on a first mount, wherein the first mount has at least one mounting interface with which the first mount is attached to or secured in a vehicle component, and (b) a functional unit placed or formed on a second mount, to which the detection unit is or can be dedicated, wherein the second mount has at least one connecting interface for connecting the second mount to the first mount.

The detection device can also be referred to as a sensor module, for example. The detection device can contain all of the elements necessary for the operation thereof, and therefore for generating or forming at least one type of detection information. The detection device can also comprise means with which this detection information can be stored and/or transmitted. The detection device can comprise a detection means, or sensor, for example, which is attached to a vehicle component, in particular therein or thereon, and which detects information for the intended use of the vehicle component when it is installed in or on a vehicle, while the vehicle is in use, and can therefore provide feedback specific to the operation of the vehicle. In other words, the detection device can be used for monitoring the operation of the vehicle component while the vehicle is in use.

The vehicle component to which the detection device is attached can be part of a land, and/or water, and/or air vehicle, for example. The vehicle component can therefore be installed, or intended for installment, on a ship, an airplane or helicopter, or a motor vehicle, in particular an automobile or utility vehicle, or a rail vehicle, in particular a train. The vehicle component can form a vehicle wheel, in particular a rim, a least one component of a rotor in an electric machine, an axle for a vehicle, in particular a rail vehicle, or a gear component. In particular, the detection device can be used for monitoring a moving vehicle component during the intended use of the vehicle.

The detection device is composed of at least two parts, or comprises at least two parts or modules that are connected to one another, which can be separated from one another, in particular without damaging either of the parts. The first module, or the first mount, has a mounting interface with which the mount can be or is directly or indirectly connected to the vehicle component. The mount can be attached to the vehicle component with mounting interface. The mounting interface can comprise a suitable surface, for example, with which the mount can adhere in a material bonded manner directly to the vehicle component. The mounting interface can also be structured such that the first mount can be attached to the vehicle component.

The first mount comprises a detection unit that is configured to detect at least one physical and/or chemical value, which can also include biological sensors that detect chemical values in the present sense. By connecting the first mount directly to the vehicle component, i.e. such that it is not cushioned or insulated against the component, any movement and/or vibration and/or temperature, etc. of the vehicle component can be accurately detected by the first detection unit on the mount. The detection unit is configured to detect physical and/or chemical values for this purpose, e.g. vibrations and/or temperature, and to form or generate detection information therefrom.

The detection device can comprise at least one detection unit, and the at least one detection unit can have at least one detection means, wherein the detection means can be designed as a gyroscope, and/or temperature sensor, and/or rotation angle sensor, and/or pressure sensor, and/or humidity sensor, and/or vibration sensor, and/or inclination sensor, and/or acceleration sensor.

A functional unit to which the detection unit can be or is functionally dedicated is placed or formed on the second mount. This second mount is preferably releasably connected to the first mount. In other words, the detection device is composed of at least two mounts that are releasably connected to one another, which contain at least somewhat different functional elements. The two mounts can be or are connected to one another by a connecting interface.

The functional unit may comprise at least one power unit, in particular an electrical power storage unit, wherein the detection unit can be or is supplied with electricity from the power unit through an interface. The detection device therefore has means that are used for determining detection information for the operation thereof. By way of example, a power or voltage supply for the detection unit can be designed to detect the physical and/or chemical values using the power unit. By way of example, the power unit can contain at least one electrical power storage unit and/or at least one power management means and/or one interface for electrically connecting the other components of the functional unit and/or the detection unit to an external power source.

A battery and/or rechargeable battery can be used for the electrical power storage unit. The electrical power storage unit can be a removable or permanent component of the functional unit. The interface element can form a wireless/contactless, or hard wired/contact connection to an external power source that conducts electricity. By way of example, the interface can be a plug/socket interface, in particular for connecting a power cord, and/or it can form a charger interface that can be charged inductively. A power management means can comprise a control unit that monitors and/or controls a charging and/or discharging process in the power storage unit. The power management means can also comprise a transformer and/or monitor for the power supply for the other components of the functional unit and/or the detection unit. The power unit can also contain at least one means for harvesting power. This means that during the intended operation of the vehicle component, (non-electric) forces acting on the power unit are converted to electricity. The electricity obtained in this manner can be stored in an energy storage unit and/or supplied directly to other functional means in the functional unit and/or the detection unit.

In another, optional embodiment, the detection unit can comprise at least one detecting means with which information, in particular detection information from the detection means, can be or is transmitted through an interface to the functional unit. This transmission can take place with or without contact. In other words, the detection information can be transmitted from the first mount to the second mount through uninterrupted contact or a permanent connection, or through an at least partially contactless data or signal transfer.

The functional unit can comprise at least one transmitter, which is configured to transmit information, in particular detection information, between the functional unit and a communication device, in particular a higher-order communication device, in a wireless manner or through a hard wired connection.

The information transmission between the transmitter and the higher-order communication device can be unidirectional or bidirectional. The communication device can be a higher-order communication device, for example, i.e. the communication device can be part of a computer network that is separate from the detection device. The communication device can be configured to receive detection information that has been detected or generated by at least two, in particular numerous, detection devices, and then evaluate and/or further process this information. In a vehicle, the higher-order communication device can be a vehicle control unit, or at least part of a vehicle and/or motor control unit, and it can receive the detection information transmitted and modified by the detection device via at least one receiver. The receiver can comprise an antenna, for example. The functional unit in the detection device can comprise a receiver that can receive information from the higher-order communication device. By way of example, information sent from the higher-order communication device can have an effect on a pre-processing modification of the detection information.

The first mount can be releasably or permanently attached to the vehicle component via the mounting interface, i.e. in or on the vehicle component. The mount is or can be preferably attached to the vehicle component in a materially bonded manner, i.e. in or on the vehicle component. The shape of the mounting interface can be adapted to a fastening location on the vehicle component, such that the contact surface between the first mount and the vehicle component is as large as possible in the assembled state. The first mount can be attached in a material bonded manner to the vehicle component, e.g. with adhesive, i.e. such that it cannot be removed without damaging it. The first mount can also be integrated in the vehicle component during the production process. This means that if the vehicle component is at least partially produced in an injection molding process, the first mount is molded thereto. The important thing here is that the interface on the first mount for connecting to the second mount remains exposed, such that at least in the assembled state, the second mount can be or is connected to the first mount.

The first and second mounts, in particular the mounting body and the mounting element, each have surfaces that face one another in the assembled state, and which come in contact with one another, at least in part, in particular entirely. The two surfaces preferably have shapes corresponding to one another, at least in part, in particular entirely. These corresponding shapes can be substantially flat surfaces.

The second mount can be or is attached to the first mount via the connecting interface in a releasable or permanent manner. The second mount is and/or can be preferably connected to the first mount in a force-fitting and/or material bonded manner. The connecting interface between the first and second mounts can comprise a mechanical or supporting connection, i.e. the second mount is indirectly connected to the vehicle component via the first mount. In other words, the second mount, comprising the functional unit, is supported by just the first mount. The module formed by the mounts can be attached to the vehicle component by just the first mount. Consequently, the first mount can comprise the detection unit, and also be used, in particularly exclusively, as a connector for attaching to the vehicle component.

An at least force-fitting connection between the two mounts can be such that in the assembled state there is a preload force or tension. As a result, a mechanical connection of the two mounts can act on the connection with a preload force such that there is little or no relative movement between the two mounts during the intended use of the detection device.

An electrical connection between the two mounts in the assembled state can also result in a preload effect or preload force. This has the advantage that even if there is relative movement between the two mounts, the electrical connection is not interrupted due to the preload effect. By way of example, a contact at the interface between the two mounts can be preloaded, in particular by a spring and/or an elastomer, in which differences in length are compensated for by the preload, such that any relative movement between the mounts can be compensated for.

The first mount can be designed such that the detection device is reliably attached to the vehicle component during the intended use thereof, and the detection device can also detect physical and/or chemical values. The connecting interface between the first and second mounts can also be designed such that it is possible to reliably transfer data during the intended use of the vehicle component.

The second mount can be and/or is connected to the detection unit by means of a fastener, which is separate from the mounts. The fastener engages in a corresponding counter-element. As such, the fastener can be formed by a screw and/or nut and/or rivet. Being separate from the mounts means that the fastener can be removed from the mounts, or that it is a separate fastener. The fastener can also form a non-integral part of at least one, in particular both, of the mounts.

In another embodiment, the fastener can be designed, at least in part, as an integral part of at least one of the mounts. By way of example, a component of one or both mounts can be produced in the course of an additive production process and/or an injection molding process, or a molding process, in which at least a part, in particular all, of the geometric shape of the fastener is also formed during this production process. If the fastener is a snap together connection, a lug or snap-fit element is produced during the production process of at least part of the mount.

The connecting interface can comprise at least one interface element placed or formed on the first mount and a second interface element placed or formed on the second mount, both of which are or can be connected thereto in a releasable or permanent manner. The interface elements are preferably designed to form an electrically conductive contact connection when the mounts are joined together. This results in a connection for electronic data transfer when the two mounts are connected or joined together. In general, both information and electricity can be transferred, unidirectionally or bidirectionally, between the mounts. In this case, separate interface elements or the same interface elements can be used for the transfer of electricity and/or data, in particular detection information.

The interface elements can form a configuration comprising at least one engagement element and at least one counter-element, in particular in the form of a hole. One of the interface elements, dedicated to one of the mounts, can have at least one projection, which can at least temporarily engage in at least one corresponding counter-element in the other mount. The joining direction of the fastener for the mechanical connection of the mounts can preferably be parallel and/or identical to the joining direction for joining the projection with the counter-element for the electrical connection. The interface elements can form the preloaded, in particular force-fitting, connection described above. The interface elements can thus form spring-loaded contacts, in particular in the form of curved contacts, which come in contact with the contact regions on the other mount in the assembled state.

The second mount can comprise a computing unit, for example, with which information, in particular detection information, can be modified. Modification of information, in particular detection information, is understood in the present case to mean at least an editing and/or processing of this information. As such, information, in particular detection information, can be filtered and/or amplified by the computing unit. In other words, the raw data obtained with the detection means can be modified by the computing unit, i.e. amplified and/or filtered. As such, the computing unit can amplify a charge and/or process data, in particular in detection information obtained with the detection means. The modified information can then be sent to the communication device.

The second mount and/or first mount can also comprise a data memory unit in which information, in particular detection information, can be stored and/or accessed. Operational or control data for operating the detection device, in particular the detection unit, can be stored in the data storage unit.

The detection device can be designed to be attached to a vehicle component in the form of a vehicle wheel, in particular a rim, during the intended use, and to determine physical and/or chemical values acting on the vehicle wheel, in particular the rim, during the intended use and/or a testing of the vehicle wheel, in particular the rim, during its intended use and/or a testing of the vehicle wheel. It is therefore possible to determine the physical and/or chemical values that are present during an intended use of a vehicle wheel by means of the detection device. As such, the temperature and/or vibrations present in the vehicle wheel can be detected by the detection device.

The detection device can be designed or configured to detect these vibrations in a range of 0.5 Hz to 1 kHz, preferably in a range of 1 Hz to 0.5 kHz. The detection means can also detect expansions, such that it is possible to measure the expansions of metals. The detection means is preferably designed to measure expansions in a vehicle wheel, in particular in the rim, during operation thereof. This can be a rim on a passenger automobile or a utility vehicle.

The first mount can comprise a mounting body, for example, in or on which the detection unit is placed or formed, in that a part of a first or second interface element is preferably placed or formed on the mounting body. The second mount can comprise a mounting element, for example, on or in which the functional unit and a part of a first or second interface element is placed or formed. The mounting body and/or mounting element can be flat or plate-shaped. The mounting body can also have at least one surface that fits or corresponds, at least in part, in particular in its entirety, to a contoured surface, or the contact surface, of the first mount on the vehicle component. By way of example, the shape of the surface on the first mount facing the vehicle component may differ from the shape of the surface facing the other mount.

At least one of the mounts may be flat. The first and second mounts, in particular the mounting body and the mounting element, are preferably flat or plate-shaped, and the main planes of extension of the mounts, in particular the mounting body and mounting element, are parallel to one another when the first mount and second mount are joined together. The mounts, in particular the mounting body and mounting element, may also come in contact with one another, at least in part, in their assembled state.

A surface facing the vehicle component can form a flat, in particular planar, surface. The surface facing the vehicle component can also be curved, at least in part. The surface of the first mount facing the vehicle component is preferably adapted to a contact surface on the vehicle component, at least in part, in particular entirely, or corresponds to the contact surface of the vehicle component, at least in part, in particular entirely.

In addition to the detection device, the invention also relates to a vehicle, in particular a motor vehicle, comprising at least one vehicle component, on or in which at least one detection device described herein can be or is attached or secured. The vehicle can have a transmission or transmission assembly, for example, wherein the vehicle component that has the detection device is part of the transmission.

In addition to the detection device and the vehicle, the invention also relates to a method for detecting physical and/or chemical values using a detection device described herein. It may prove to be advantageous that, if a power storage unit is used, after the charging state of the power storage unit falls below that necessary for operating the detection device, it is not necessary to remove the entire detection device from the vehicle component, or replace it thereon, but instead it is possible to replace the mount comprising the power unit with an identical or similarly constructed replacement mount.

Because the sensors or detection means necessary for the detection of the physical and/or chemical values can remain unaltered on the vehicle component when replacing the power unit, maintenance and/or repair of the detection device is easy and simple. Even if one of the elements in the functional unit on the first mount malfunctions, repairs can be made easily by replacing the first mount and connecting the replacement mount to the second mount remaining on the vehicle component.

All of the advantages, details, embodiments and/or features of the detection device according to the invention can be applied to or obtained with the vehicle and the method according to the invention.

### BRIEF DESCRIPTION OF THE DRAWINGS

Certain embodiments are explained in greater detail below in reference to the exemplary embodiments shown in the drawings. Therein:

FIG. 1 shows a schematic illustration of a detection device in the unassembled state, according to one exemplary embodiment;

FIG. 2 shows a schematic illustration of a detection device in the unassembled state, according to one exemplary embodiment;

FIG. 3 shows a schematic illustration of a detection device in the unassembled state, according to one exemplary embodiment.

### DETAILED DESCRIPTION OF THE DRAWINGS

The drawings show a detection device 1 that can be attached to or secured in a vehicle component 2, with which physical and/or chemical values, in particular for the vehicle component 2, can be detected, which has a detection unit 4 placed or formed on a first mount 3 for detecting physical and/or chemical values, wherein the first mount 3 has at least one mounting interface 5 for attaching the first mount 3 to the vehicle component 2, in particular therein or thereon. There is also a functional unit 7 to which the detection unit 4 is or can be functionally dedicated, placed or formed in or on a second mount 6, wherein the second mount 6 has at least one connecting interface 8 for connecting the second mount 6 to the first mount 3.

The functional unit 7 can comprise at least one power unit 9, in particular an electrical power storage unit, wherein power from the power unit 9 is or can be supplied through an interface, in particular the connecting interface 8, to the first mount 3, in particular to the detection unit 4.

In the embodiments shown in the drawings, the connecting interface 8 comprises numerous interface elements 20, 21, 22, 23, with which the mounts 3, 6 are connected. The first interface elements 20, 21 on the two mounts 3, 6 form a mechanical connection, and the other interface elements 22, 23 on the mounts 3, 6 form an electrical or data transfer connection.

The detection unit 4 can comprise at least one detection means, and information, in particular detection information obtained with the detection means is or can be transferred by means of an interface, in particular the connecting interface 8, to the functional unit 7. The connecting interface can transfer information, in particular the detection information, between the mounts 3, 6 via the interface element 22, 23, either through a contact connection or in a contactless manner.

The functional unit 7 can comprise at least one transmitter 10, which is configured to transmit information, in particular detection information, between the functional unit 7 and a communication device 11, either through a hard-wired connection, a contact, or wirelessly.

The first mount 3 can be releasably or permanently attached to the vehicle component 2 by means of the mounting interface 5. In particular, the first mount 3 is or can be attached to the vehicle component 2 in a material bonded manner.

The second mount 6 can be or is connected releasably or permanently to the first mount 3 by means of the connecting interface 8. The second mount 6 is or can be preferably connected to the first mount 3 in a force-fitting, and/or form-fitting, and/or material bonded manner.

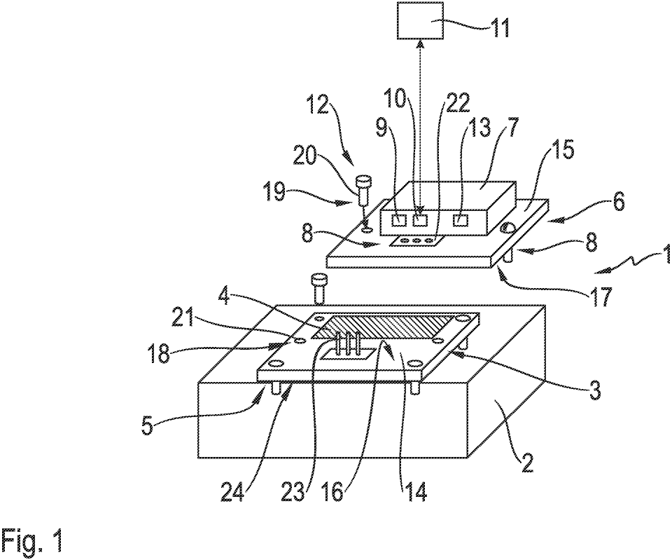

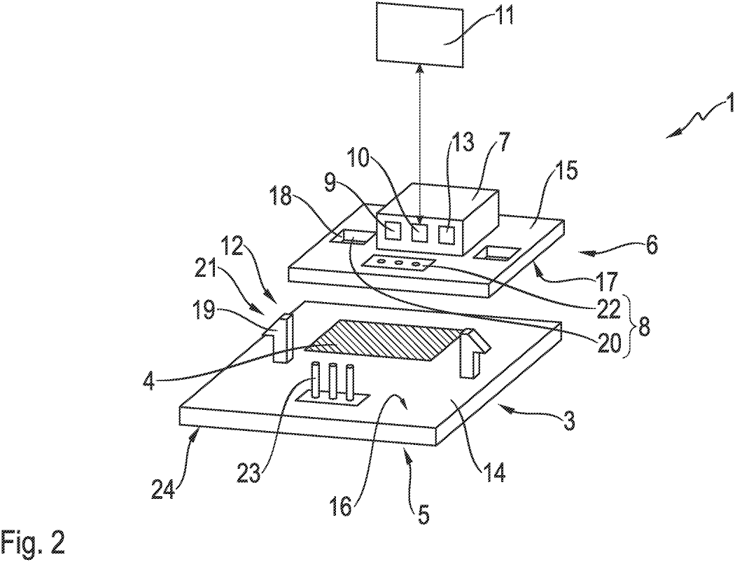

The second mount 6 is and/or can be connected to the first mount 3 by means of an fastener 12, in particular a fastening means that is formed separately from the mounts 3, 6, in that the fastener 12 forms an engagement element 19 that engages in a counter-element 18. In the embodiment shown in FIG. 1, the fastener 12 is formed by a screw, which passes through a hole in the second mount 6 and is screwed into a threaded hole in the first mount 3. In FIG. 2, the fastener 12 is an engagement element 19 in the form of a projection on the first mount 3, which engages in a counter-element 18 in the form of a hole in order to mechanically connect the two mounts 3, 6.

The fastener 12 can be a threaded shaft or rod (not shown) on the first and/or second mount 3, 6, such that after placing the two mounts 3, 6 against one another and feeding the threaded shaft through a hole intended for this in the other mount 3, 6, the mounts can be connected to one another in a force-fitting and/or form-fitting manner by means of a securing agent, e.g. a nut. A snap-fit fastener 12 or interface element 20, 21 can also be used for the mechanical connection of the two mounts 3, 6.

The connecting interface 8 can comprise a first interface element 21, 23 placed or formed on the first mount 3 and a second interface element 20, 22 placed or formed on the second mount 6, wherein the two interface elements 20, 21, 22, 23 can be or are releasably or permanently connected, and the interface elements 22, 23 are preferably designed to form an electrically conductive connection when the two mounts 3, 6 are joined to one another.

The second mount 6 can contain a computing unit 13, for example, with which information, in particular detection information, can be modified.

The detection device 1 can also be designed to be attached to a vehicle component 2 in the form of a vehicle wheel, in particular a rim, in the intended use thereof, and to determine physical and/or chemical values acting on the vehicle wheel, in particular the rim, during the intended use thereof and/or during a testing of the vehicle wheel, in particular the rim, during its intended use and/or during a testing of the vehicle wheel.

The first mount 3 can comprise a mounting body 14 that is flat or plate-shaped in particular, on or in which the detection unit 4 is placed or formed. A part of a first or second interface element is preferably placed or formed on the mounting body 14. The second mount 6 can comprise a flat or plate-shaped mounting element 15, on which the functional unit 7 and part of a first or second interface element 20, 21, 22, 23 is placed or formed.

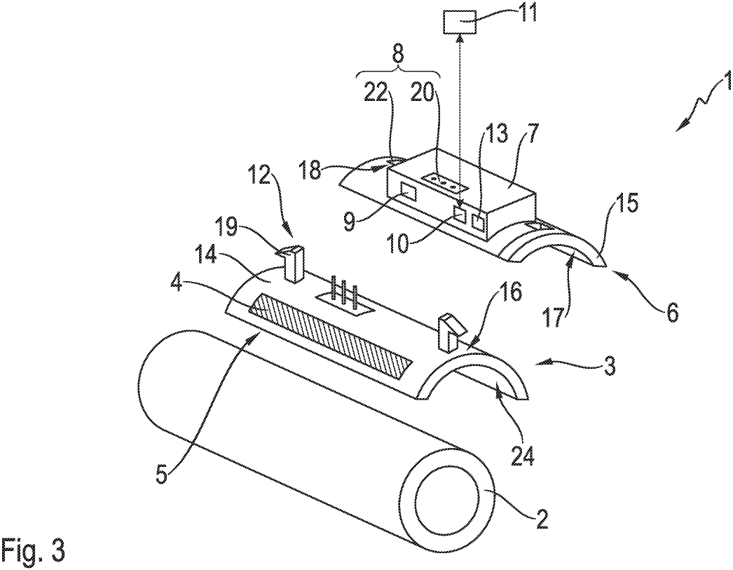

It can be seen from the embodiment shown in FIG. 3 that the surface 24 of the first mount 3 facing the vehicle component 2, in particular the mounting body 14, can have a shape adapted to the shape of the contact surface on the vehicle component 2.

The surfaces 16, 17 of the mounts 3, 6 facing one another in the assembled state can have shapes that are similar or correspond to one another, at least in part, in particular entirely.

At least one mount 3, 6 can have a flat or plate-like shape, at least in part, in particular entirely. The first and second mounts 3, 6 preferably have at least partially, in particular entirely, flat shapes or plate-like shapes, wherein the main directions of extension of the mounts 3, 6 are parallel to one another in the assembled state (not shown) of the first mount 3 and second mount 6. Even if the surfaces are curved, see FIG. 3, the main axes of extension in the mounts 3, 6 can be parallel.

The invention also relates to a vehicle (not shown), in particular a motor vehicle, comprising at least one vehicle component 2, on or in which a detection device 1 described herein is or can be attached or secured.

The invention also comprises a method for detecting physical and/or chemical values by means of the detection device 1 described herein. In particular if part of the second mount 6 malfunctions, and in particular if a part of the functional unit 7 malfunctions, it is advantageous that the detection device 1 can be simply and easily restored to its operating state by replacing the second mount 6 and connecting or attaching the replacement mount to the (first) mount 3, which is attached to the vehicle component. Alternatively or additionally, the scope of function of the detection device 1 can be altered in the course of replacing a first second mount 6 with another second mount 6. By way of example, the original and replacement second mounts 6 may differ in terms how they are populated, in particular in terms of the respective functional units 4. As a result, when a second mount 6 is used that has a different functional scope, it is possible to obtain a different functionality of the detection device 1. By way of example, the functional unit 7 may have a supplementary sensor, with which a detection unit on the first mount is able to detect different, similar, or identical physical and/or chemical values.

List of Reference Symbols

| | |
|---|---|
| 1 | detection device |
| 2 | vehicle component |
| 3 | first mount |
| 4 | detection unit |
| 5 | mounting interface |
| 6 | second mount |
| 7 | functional unit |
| 8 | connecting interface |
| 9 | power unit |
| 10 | transmitter |
| 11 | communication device |
| 12 | fastener |
| 13 | computing unit |
| 14 | mounting body on 3 |
| 15 | mounting element on 6 |
| 16 | surface on 14 |
| 17 | surface on 15 |
| 18 | counter-element |
| 19 | engagement element |
| 20 | interface element on 6 |
| 21 | interface element on 6 |
| 22 | interface element on 3 |
| 23 | interface element on 3 |
| 24 | surface on 14 |

1. A detection device that is attachable to or secured in a vehicle component, with which physical and/or chemical values can be detected, comprising:
a detection unit placed or formed on a first mount for detecting a physical and/or chemical value, wherein the first mount has at least one mounting interface for attaching the first mount to the vehicle component ; and
a functional unit to which the detection unit is dedicated, placed or formed on or in a second mount, wherein the second mount has at least one connecting interface for connecting the second mount to the first mount .

2. The detection device according to claim 1, wherein the functional unit comprises at least one power unit, the at least one power unit including an electrical power storage unit, wherein power from the power unit is supplied to the detection unit through an interface.

3. The detection device according to claim 1, wherein the detection unit comprises at least one detection device, wherein information from the detection device is transferred to the functional unit through an interface.

4. The detection device according to claim 1, wherein the functional unit comprises at least one transmitter, which is configured to transmit information between the functional unit and a communication device through at least one of a hard- wired connection and wirelessly.

5. The detection device according to claim 1, wherein the first mount is releasably or permanently attachable to the vehicle component with the mounting interface, wherein the mount can be or is attached to the vehicle component in a material bonded manner .

6. The detection device according to claim 1, wherein the second mount is releasably or permanently connected to the first mount with the connecting interface, wherein the second mount is connected to the first mount in at least one of a force-fitting, form-fitting, and material bonded manner.

7. The detection device according to claim 1, wherein the second mount is connected to the detection unit by a fastener that is separate from the mounts, wherein the fastener includes an engagement element that engages with a counter-element .

8. The detection device according to claim 1, wherein the connecting interface comprises a first interface element that is placed or formed on the first mount, and a second interface element that is placed or formed on the second mount, wherein the first interface element and the second interface element are releasably or permanently connected to one another, and wherein the first interface element and the second interface element form an electrically conductive connection when the the first mount and the second mount are connected to one another.

9. The detection device according to claim 1, wherein the second mount contains a computing unit .

10. The detection device according to claim 1, wherein the detection device is configured to be attached to the vehicle component, wherein the vehicle component is at least one of a vehicle wheel and a rim .

11. The detection device according to claim 1, wherein the first mount comprises a flat mounting body, on or in which the detection unitis placed or formed, wherein a part of a first or second interface element is placed or formed on the mounting body.

12. The detection deviceaccording to claim 1, wherein the second mount comprises a flat mounting element, on which the functional unitand part of a first or second interface element are placed or formed.

13. The detection device according to claim 1,
wherein the first and second mounts are both flat mounts,
wherein the main directions of extension of the mounts are parallel to one another when the first mountand the second mountare joined to one another.

14. A motor vehicle comprising at least one vehicle component, to or in which a detection device according to claim 1 is attached .

15. A method for detecting physical and/or chemical values by withthe detection device according to claim 1.

16. The detection device of claim 1, wherein the detection unit is a sensor.

17. The detection device according to claim 16, wherein the sensor includes at least one of a gyroscope, a temperature sensor, a rotation angle sensor, a pressure sensor, a humidity sensor, a vibration sensor, an inclination sensor, and an acceleration sensor.

18. The detection device according to claim 1, wherein the functional is a wireless or wired transmitter which includes a wired connection and/or an antenna.

19. The detection device according to claim 1, wherein the connecting interface includes a mechanical structure extending between the first mount and the second mount.

20. A detection device, comprising:
a sensor secured to a first mount, the sensor being configured for detecting a physical and/or chemical value of a vehicle component, wherein the first mount has at least one mounting interface for attaching the first mount to the vehicle component; and
a functional unit to which the sensor is dedicated, the functional unit being attached via a second mount, wherein the second mount has at least one connecting interface for connecting the second mount to the first mount,
wherein the sensor includes at least one of a gyroscope, a temperature sensor, a rotation angle sensor, a pressure sensor, a humidity sensor, a vibration sensor, an inclination sensor, and an acceleration sensor.
